(19) United States
(12) Patent Application Publication
(10) Pub. No.: US 2026/0228482 A1
(43) Pub. Date: Aug. 6, 2026

(54) LARGE LANGUAGE MODEL PROXY AGGREGATOR

(71) Applicant: SAP SE, Walldorf (DE)

(72) Inventor: Jasmond Ming Quan Loh, Singapore (SG)

(21) Appl. No.: 19/042,695

(22) Filed: Jan. 31, 2025

(51) Int. Cl. G06N 3/042

(52) U.S. Cl. CPC G06N 3/042

(57) ABSTRACT

In an example embodiment, a filtering system is introduced to optimize the organization and processing of LLM request. By carefully categorizing queries based on their input prompt lengths and anticipated output token numbers, the workflow is streamlined prior to submission to an LLM inference server. Each bucket corresponds to a different range of number of tokens (both input and output combined). Each bucket also has a size, indicating the maximum number of requests that can be placed in the bucket. Each request is assigned to a bucket when it is received, and when a bucket is filled the requests in the bucket are batched together and send to the LLM for processing.

### TECHNICAL FIELD

This document generally relates to computer systems. More specifically, this document relates to a large language model proxy aggregator.

### BACKGROUND

A large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

LLMs often rely heavily on Graphics Processing Units (GPUs) for both training and inference due to their ability to handle complex computations more efficiently than traditional Central Processing Units (CPUs). GPUs are designed for parallel processing, allowing them to perform many calculations simultaneously, which is essential for the vast number of operations LLMs require. Training these models involves adjusting billions of parameters across vast datasets, and GPUs accelerate this by enabling parallel processing of matrix operations, such as matrix multiplications, which are central to neural networks. These operations are much faster on GPUs compared to CPUs, significantly reducing the time needed for training and enabling the model to learn from large datasets quickly.

### BRIEF DESCRIPTION OF THE DRAWINGS

The present disclosure is illustrated by way of example and not limitation in the figures of the accompanying drawings, in which like references indicate similar elements.

FIG. 1 is an example of naïve batching, in accordance with an example embodiment.

FIG. 2 is an example of continuous batching, in accordance with an example embodiment.

FIG. 3 is a block diagram illustrating a system for processing LLM requests, in accordance with an example embodiment.

FIG. 4 is a flow diagram illustrating a method for processing LLM prompts, in accordance with an example embodiment.

FIG. 5 is a block diagram illustrating a software architecture, in accordance with an example embodiment.

FIG. 6 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

In addition to permitting much faster operations than traditional CPUs, GPUs also provide high memory bandwidth, which is beneficial when working with the massive amounts of data and model parameters involved in LLMs. The large memory capacity of GPUs allows them to store more data and run larger batches, speeding up both training and inference. When dealing with extremely large models, multiple GPUs can be used in parallel, either by splitting the data across GPUs or by distributing parts of the model itself, further improving efficiency.

When an LLM is implemented in a cloud environment, an inference server may be provided to receive and process the prompts generated by user devices. Users may submit requests with varying prompt lengths and maximum token values. While this flexibility is beneficial, it can result in an inefficient use of the video random access memory (VRAM) of a GPU used by the LLM inference servers'memory management and scheduling subsystem component during batching.

This inefficiency may lead to increased response latency for inputs with shorter prompt lengths and smaller output token size.

The inference process in an LLM comprises two stages: prefill and auto regressive. In the prefill stage, the input prompt is converted into tokens, and one token occupies approximately 1 MB of memory in most LLMs. Thus, with a 2048-token input prompt, there is approximately 2 GB of memory usage. This memory, however, is also used for the “Auto-aggressive” inference stage.

The prefill stage refers to the process of feeding a model with a prompt or initial input to help it start generating text. During this stage, the model has already been pre-trained on a massive corpus of text, so when it is given an initial input, it processes that input (such as a few words or a question) and prepares to generate the subsequent tokens (words, phrases, etc.).

In this phase, the model doesn't generate any new tokens on its own but rather fills its internal state with information from the prompt or context. This allows the model to understand the initial input and predict what would logically come next based on patterns it has learned during training. The prefill stage is often associated with the initial “embedding” of the input, where each word or token is transformed into a numerical representation that the model can work with.

The autoregressive stage is where the actual text generation happens. In an autoregressive model like GPT, the model generates one token at a time, based on the input and all previously generated tokens. After the model has processed the initial prompt during the prefill stage, it begins generating text one token at a time, appending each new token to the input sequence.

In this phase, the model uses the context from the prompt and the previously generated tokens to predict the next token in the sequence. It then uses that prediction as part of the input to predict the following token, and so on, iterating this process until the output sequence reaches the desired length or meets a stopping criterion (like an end-of-sequence token).

For efficiency, inference servers may batch multiple prompts together. But it is also then beneficial to optimize this batching. Specifically, it is desirable to minimize data transfer between batches whenever possible. Utilizing techniques such as continuous batching, new prompts can be added to a batch if space is available.

In continuous batching, the system dynamically adjusts the batch size based on the speed of data processing and the capacity of the hardware (like the GPU). For example, if the GPU is ready to process more data, the system can increase the batch size. On the other hand, if the GPU is occupied with processing data, the batch size can be adjusted downward. Instead of waiting until every request in the batch has completed generation to determine a batch size, an iteration-level scheduling process may be performed where the batch size is determined per iteration. The result is that once a request in a batch has completed generation, a new request can be inserted in its place, yielding higher GPU utilization than static batching.

This method, however, introduces some latency due to the need to transfer new prompt data into an existing batch and the fact that the number of tokens in an input prompt, and ultimately the number of tokens in the generated output, may be unknown.

It would be beneficial, therefore, to have a system that is able to maximize the likelihood that prompts are quickly added to batches while still minimizing any inefficiency in the organization of the batches themselves. This inefficiency may be caused by having a batch with requests of varying sizes that result in the need to add in additional requests to have a more consistent batch length.

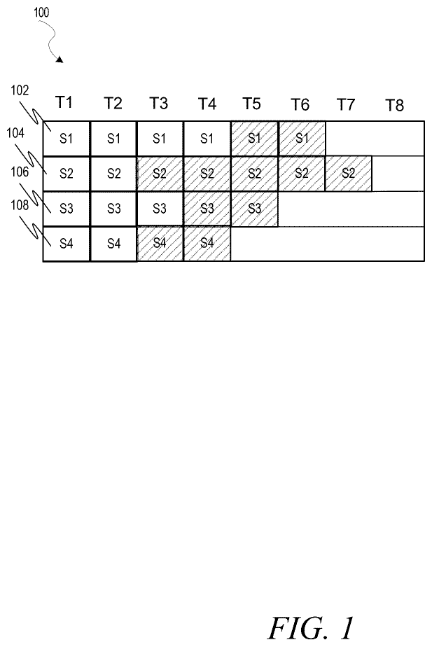

FIG. 1 is an example of naïve batching, in accordance with an example embodiment. Here, requests S1 102, S2 104, S3 106, and S4 108 are added to a batch 100. Thus, each row represents a request that could potentially be processed in parallel to each other by the CPU. This batch 112 is then sent as a whole to the LLM for processing. Notably, however, the LLM needs to respond to this batch by sending the batch 110 back with output tokens generated. The problem is that, as depicted here, the generated responses are all completed at different times. Here, for example, request S1 102 has three input tokens (the non-shaded squares) and two output token (the shaded squares). Likewise request S2 104 has two input tokens and five output tokens. Thus, all of the responses are held until they are all generated, meaning that the response generated for request S1 102, S3 106, and request S4 108 are all held until the response is generated for request S2 104, at which point they are all returned together.

This is inefficient use of the GPU, which could be used to process requests during the down times in each row of the batch 100. In other words, the blank squares in this figure represent missed opportunities for GPU processing.

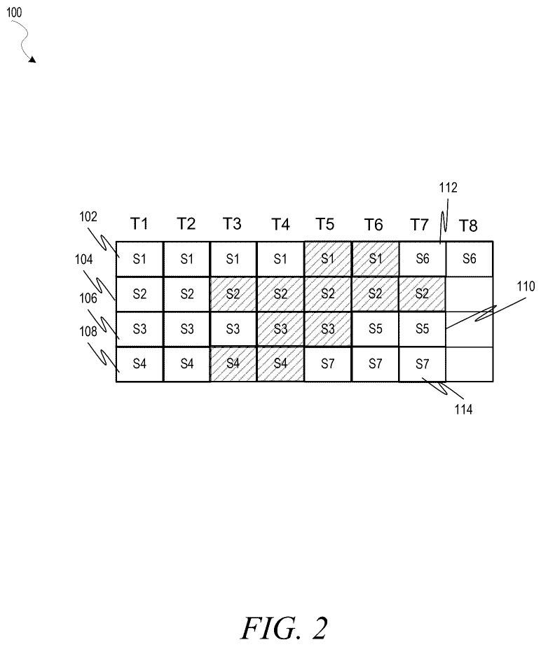

In continuous batching, rather than waste this waited time where available GPU cycles could be used to process additional requests, those additional request are, if possible, added to the batch. FIG. 2 is an example of continuous batching, in accordance with an example embodiment. Here, for example, request S6 112 could be added in the row of request S1 102 and begun to be processed while the response to request S2 104 is still being generated. Likewise, request S5 110 could be added in the row of request S3 106 and request S7 114 could be added in the row of request S4 108.

While this reduces waste of GPU resources, it may increase latency as it takes time to determine which requests will fit into the spaces in each row and it also takes time to actually transfer those additional requests to the batch.

In order to ensure consistent output, it is desirable to have all the prompts reside within the same batch to reduce data transfer. In an example embodiment, to achieve this goal, both the requests'input prompt length and expected output tokens should, as a sum, fall within a similar range, eliminating or at least reducing the need to use continuous batching.

In an example embodiment, a filtering system is introduced to optimize the organization and processing of LLM request. By carefully categorizing queries based on their input prompt lengths and anticipated output token numbers, the workflow is streamlined prior to submission to an LLM inference server. Each bucket corresponds to a different range of number of tokens (both input and output combined). Each bucket also has a size, indicating the maximum number of requests that can be placed in the bucket. Each request is assigned to a bucket when it is received, and when a bucket is filled the requests in the bucket are batched together and send to the LLM for processing. Since the requests in a bucket all have a number of tokens that are close in number to each other, this eliminates the need to perform continuous batching, since there will not be as much “empty space” in the batch to fill. This also, therefore, eliminates the latency introduced by continuous batching.

This approach is also superior to the naïve batching approach, since the efficiency of the GPU is still maintained even without using continuous batching.

In other words, the filtering system directs batched requests to designated LLM deployments, tailored to handle the specific sizes of these groups. Multiple such deployments may be utilized to address various query batches originating from the filtering system.

Advanced artificial intelligence can be used to calculate the ideal number of batches, optional input prompt lengths, and output token sizes for each LLM deployment. This approach leads to improved efficiency within the LLM inference server, ultimately resulting in reduced latency and increased throughput due to minimized data transfer during the inference process.

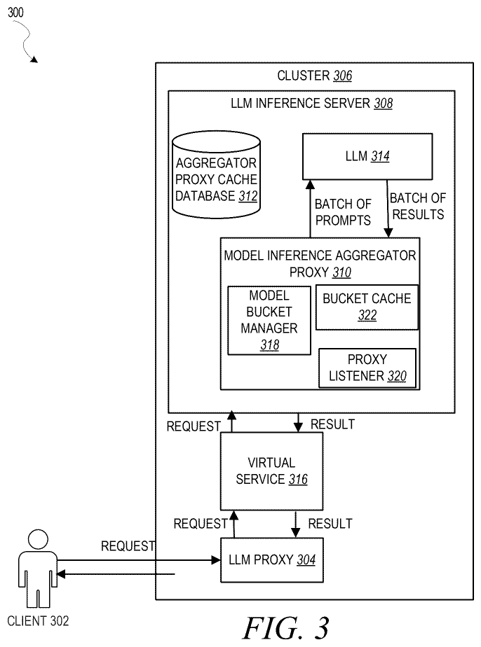

FIG. 3 is a block diagram illustrating a system 300 for processing LLM requests, in accordance with an example embodiment. Clients, such as client 302, send requests to an LLM proxy 304 in cluster 306. The cluster may be, for example, a Kubernetes™ cluster.

Kubernetes™ is an open-source container orchestration platform that automates the deployment, scaling, and management of containerized applications. Containers are a way of packaging software and its dependencies into a standardized unit, which can be run consistently across different environments. Kubernetes helps manage these containers in large, dynamic environments.

The LLM proxy 304 then sends the requests to an LLM inference server 308. The LLM inference server 308 includes a model inference aggregator proxy 310, an aggregator proxy cache database 312, and an LLM 314. It should be noted that while LLM 314 is depicted here as being contained inside the LLM inference server 308, which is itself contained within cluster 306, embodiments are foreseen where the LLM 314 is hosted in a different location and/or by a different entity than hosts the LLM inference server 308. Embodiments are also foreseen where the LLM inference server 308 is itself deployed within a different cluster than cluster 306.

The aggregator proxy cache database 312 need not be contained within the LLM inference server 308 and could also conceivably be hosted elsewhere.

When a user request is received by the LLM inference server 308, a virtual service 316 is launched to handle interfacing of that request to the LLM 314. In an example embodiment, the virtual service 316 is modified to cause the user request to be redirected to the model inference aggregator proxy 310 rather than directly to the LLM 314.

The model inference aggregator proxy 310 may itself contain a model bucket manager 318, a proxy listener 320, and bucket cache 322 containing a plurality of buckets. Each bucket is assigned a timeout period after which it notifies the model bucket manager 318. Each bucket corresponds to a different range of quantity of input tokens and output tokens. When a request comes in, the model bucket manager 318 records request metadata in the aggregator proxy cache database 312 and places the request into one of the buckets in the bucket cache 322. Requests within a bucket are then bundled into a multi-message request that is then forwarded to the LLM 314 for processing. The aggregator proxy cache database 312 may contain, for example, identifications of requests and may reference these identifications when results are received from the LLM 314. The response from the LLM 314 is essentially also a batch that is then split according to their corresponding responses (using the identifications from aggregator proxy cache database 312) before being returned to the client 302 via the LLM proxy 304.

It should be noted that the number of output tokens for a given request can be estimated in a number of different ways. In some instances, the request may specify a maximum number of output tokens. This maximum number could either be taken itself as an estimate of the number of output tokens or could be adjusted based on historical information about performance of a corresponding model. For example, some models may consistently output less than the maximum number of requested output tokens. The average number of output tokens for the model during performance testing could be taken as the estimated number of output tokens (presuming the maximum number of output tokens requested was more than that average). In other instances, the maximum number of requested output tokens can be adjusted downwards by a set percentage (e.g., reduced to 70% of the maximum number of output tokens requested).

In instances where the request does not specify a maximum number of output tokens, a default number of output tokens may be assigned.

More sophisticated ways to estimate the number of output tokens for a given request are also possible. For example, a separate machine learning model can be trained to predict a number of output tokens for a given request containing a set number of input tokens. Features input to this model could include the number of input tokens but also could include additional features of the request, such as its content. For example, a request to write lyrics to a song would likely produce more output tokens than a request to generate an opening sentence for a book, since song lyrics are usually longer than a single sentence.

Specifically, the machine learning model may be trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbors, decision trees, and hidden Markov models.

In an example embodiment, a machine learning algorithm used to train a machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of this machine learning model may take place as a dedicated training phase. In other example embodiments, the machine learning models may be retrained dynamically at runtime based on, for example, developer or user feedback.

LLMs used to generate information are generally referred to as Generative Artificial Intelligence (Gen AI) models. A Gen AI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs comprise a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modeling. This contrasts with prior art solutions that looked at a text sequence either from left to right or combined left to right and right to left. A bidirectionally trained language model has a deeper sense of language context and flow than single-direction language models.

More specifically, the transformer encoder reads the entire sequence of information, and thus is considered to be bidirectional (or, alternatively, non-directional). This characteristic allows the model to learn the context of a piece of information based on all its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory) until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, though a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

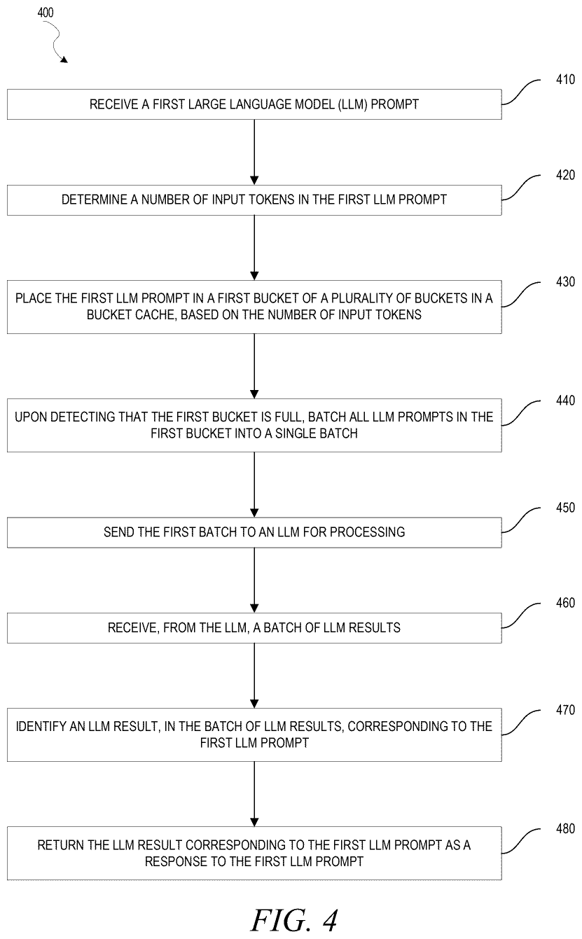

FIG. 4 is a flow diagram illustrating a method 400 for processing LLM prompts, in accordance with an example embodiment.

At operation 410, a first large language model (LLM) prompt is received. At operation 420, a number of input tokens in the first LLM prompt is determined. This number may be obtained by, for example, counting the input tokens in the first LLM prompt. At operation 430, the first LLM prompt is placed in a first bucket of a plurality of buckets in a bucket cache, based on the number of input tokens. It may also be based on other factors, such as the number of output tokens expected.

At operation 440, upon detecting that the first bucket is full, all LLM prompts in the first bucket are batched into a single batch. At operation 450, the first batch is sent to an LLM for processing. At operation 460, a batch of LLM results is received from the LLM.

At operation 470, an LLM result, in the batch of LLM results, is identified corresponding to the first LLM prompt. This may be performed by comparing identifications in the batch of LLM results to identifications of LLM prompts. At operation 480, the LLM result corresponding to the first LLM prompt is returned as a response to the first LLM prompt.

In view of the disclosure above, various examples are set forth below. It should be noted that one or more features of an example, taken in isolation or combination, should be considered within the disclosure of this application.

Example 1 is a system comprising: at least one hardware processor; a non-transitory computer-readable medium storing instructions that, when executed by the at least one hardware processor, cause the at least one hardware processor to perform operations comprising: receiving a first large language model (LLM) prompt; determining a number of input tokens in the first LLM prompt; placing the first LLM prompt in a first bucket of a plurality of buckets in a bucket cache, based on the number of input tokens; upon detecting that the first bucket is full, batching all LLM prompts in the first bucket into a single batch; sending the first batch to an LLM for processing; receiving, from the LLM, a batch of LLM results; identifying an LLM result, in the batch of LLM results, corresponding to the first LLM prompt; returning the LLM result corresponding to the first LLM prompt as a response to the first LLM prompt.

In Example 2, the subject matter of Example 1 includes, wherein the operations further comprise: estimating a number of output tokens that will be generated for the first LLM prompt; and wherein the placing the first LLM prompt in the first bucket is further based on the estimated number of output tokens.

In Example 3, the subject matter of Example 2 includes, wherein the estimating is performed based on a type of the LLM.

In Example 4, the subject matter of Examples 2-3 includes, wherein the estimating is performed based upon a maximum number of output token specified by the first LLM prompt.

In Example 5, the subject matter of Examples 2-4 includes, wherein the estimating is performed based upon a default maximum number of output tokens.

In Example 6, the subject matter of Examples 2-5 includes, wherein the estimating is based on historical information from performance testing of the LLM.

In Example 7, the subject matter of Examples 2-6 includes, wherein the estimating is performed by a machine learning model trained to estimate a number of output tokens from one or more features of the first LLM prompt.

In Example 8, the subject matter of Examples 1-7 includes, wherein the first LLM prompt is received from a virtual service configured to send the first LLM prompt to a model inference aggregator proxy instead of directly to the LLM.

In Example 9, the subject matter of Examples 1-8 includes, wherein the identifying comprises checking an identification, in an aggregator proxy cache database, for the first LLM prompt.

Example 10 is a method comprising: receiving a first large language model (LLM) prompt; determining a number of input tokens in the first LLM prompt; placing the first LLM prompt in a first bucket of a plurality of buckets in a bucket cache, based on the number of input tokens; upon detecting that the first bucket is full, batching all LLM prompts in the first bucket into a single batch; sending the first batch to an LLM for processing; receiving, from the LLM, a batch of LLM results; identifying an LLM result, in the batch of LLM results, corresponding to the first LLM prompt; returning the LLM result corresponding to the first LLM prompt as a response to the first LLM prompt.

In Example 11, the subject matter of Example 10 includes, estimating a number of output tokens that will be generated for the first LLM prompt; and wherein the placing the first LLM prompt in the first bucket is further based on the estimated number of output tokens.

In Example 12, the subject matter of Example 11 includes, wherein the estimating is performed based on a type of the LLM.

In Example 13, the subject matter of Examples 11-12 includes, wherein the estimating is performed based upon a maximum number of output tokens specified by the first LLM prompt.

In Example 14, the subject matter of Examples 11-13 includes, wherein the estimating is performed based upon a default maximum number of output tokens.

In Example 15, the subject matter of Examples 11-14 includes, wherein the estimating is based on historical information from performance testing of the LLM.

In Example 16, the subject matter of Examples 11-15 includes, wherein the estimating is performed by a machine learning model trained to estimate a number of output tokens from one or more features of the first LLM prompt.

In Example 17, the subject matter of Examples 10-16 includes, wherein the first LLM prompt is received from a virtual service configured to send the first LLM prompt to a model inference aggregator proxy instead of directly to the LLM.

In Example 18, the subject matter of Examples 10-17 includes, wherein the identifying comprises checking an identification, in an aggregator proxy cache database, for the first LLM prompt.

Example 19 is a non-transitory machine-readable medium storing instructions which, when executed by one or more processors, cause the one or more processors to perform operations comprising: receiving a first large language model (LLM) prompt; determining a number of input tokens in the first LLM prompt; placing the first LLM prompt in a first bucket of a plurality of buckets in a bucket cache, based on the number of input tokens; upon detecting that the first bucket is full, batching all LLM prompts in the first bucket into a single batch; sending the first batch to an LLM for processing; receiving, from the LLM, a batch of LLM results; identifying an LLM result, in the batch of LLM results, corresponding to the first LLM prompt; returning the LLM result corresponding to the first LLM prompt as a response to the first LLM prompt.

In Example 20, the subject matter of Example 19 includes, wherein the operations further comprise: estimating a number of output tokens that will be generated for the first LLM prompt; and wherein the placing the first LLM prompt in the first bucket is further based on the estimated number of output tokens.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

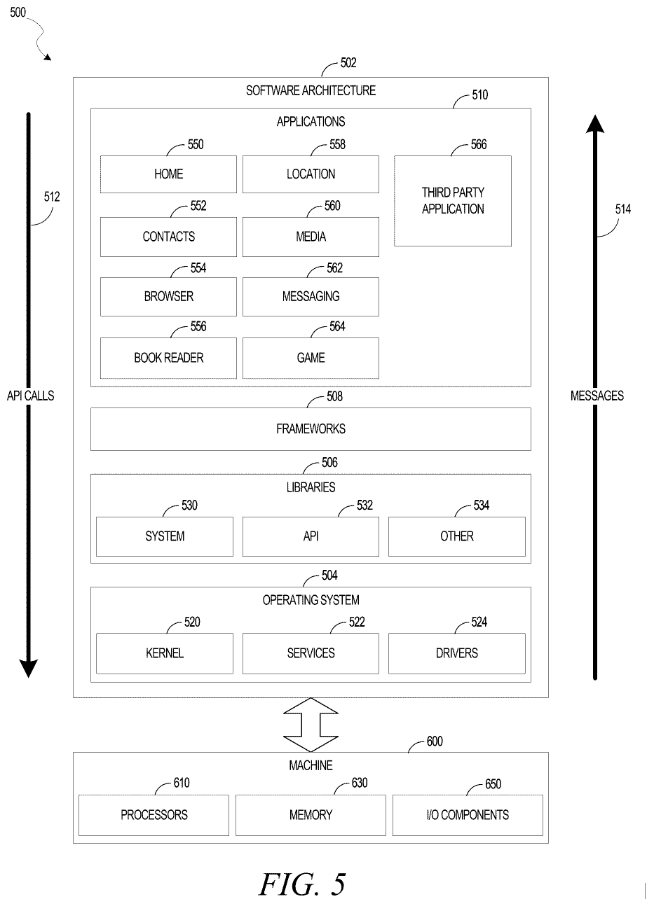

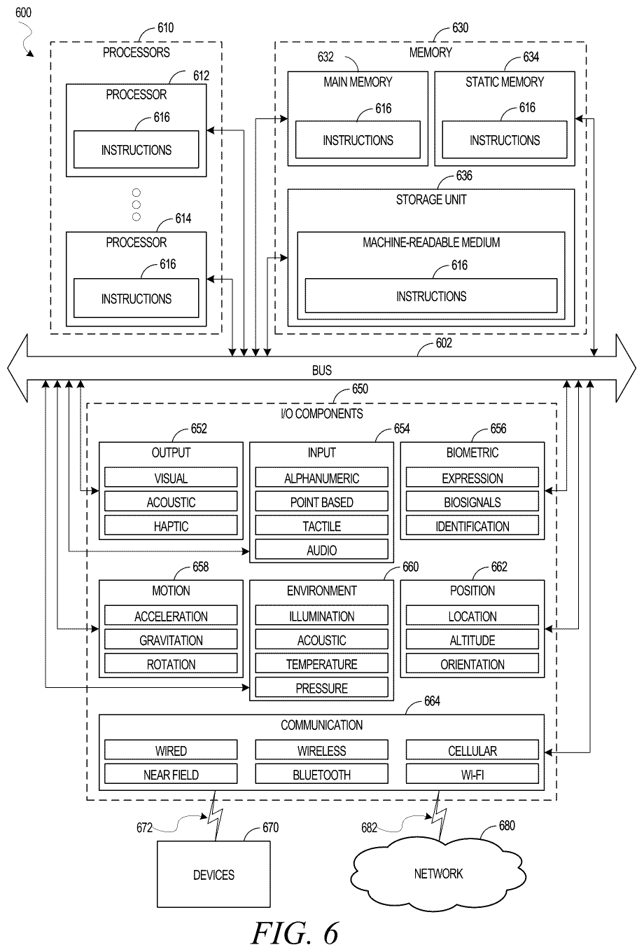

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that comprises processors 610, memory 630, and input/output (I/O) components 650. In this example architecture, the software architecture 502 can be conceptualized as a stack of layers where each layer may provide a particular functionality. For example, the software architecture 502 comprises layers such as an operating system 504, libraries 506, frameworks 508, and applications 510. Operationally, the applications 510 invoke API calls 512 through the software stack and receive messages 514 in response to the API calls 512, consistent with some embodiments.

In various implementations, the operating system 504 manages hardware resources and provides common services. The operating system 504 comprises, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionalities. The services 522 can provide other common services for the other software layers. The drivers 524 are responsible for controlling or interfacing with the underlying hardware, according to some embodiments. For instance, the drivers 524 can comprise display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can comprise system libraries 530 (e.g., C standard library) that can provide functions such as memory allocation functions, string manipulation functions, mathematic functions, and the like. In addition, the libraries 506 can comprise API libraries 532 such as media libraries (e.g., libraries to support presentation and manipulation of various media formats such as Moving Picture Experts Group-4 [MPEG4], Advanced Video Coding [H.264 or AVC], Moving Picture Experts Group Layer-3 [MP3], Advanced Audio Coding [AAC], Adaptive Multi-Rate [AMR] audio codec, Joint Photographic Experts Group [JPEG or JPG], or Portable Network Graphics [PNG]), graphics libraries (e.g., an OpenGL framework used to render in two dimensions [2D] and three dimensions [3D] in a graphic context on a display), database libraries (e.g., SQLite to provide various relational database functions), web libraries (e.g., WebKit to provide web browsing functionality), and the like. The libraries 506 can also comprise a wide variety of other libraries 534 to provide many other APIs to the applications 510.

The frameworks 508 provide a high-level common infrastructure that can be utilized by the applications 510, according to some embodiments. For example, the frameworks 508 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 comprise a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 to execute the method 400 of FIG. 4. Additionally, or alternatively, the instructions 616 may implement FIGS. 1-4 and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specifies actions to be taken by the machine 600. Further, while only a single machine 600 is illustrated, the term “machine” shall also be taken to comprise a collection of machines 600 that individually or jointly execute the instructions 616 to perform any one or more of the methodologies discussed herein.

The machine 600 may comprise processors 610, memory 630, and I/O components 650, which may be configured to communicate with each other such as via a bus 602. In an example embodiment, the processors 610 (e.g., a central processing unit [CPU], a reduced instruction set computing [RISC] processor, a complex instruction set computing [CISC] processor, a graphics processing unit [GPU], a digital signal processor [SP], an application-specific integrated circuit [ASIC], a radio-frequency integrated circuit [RFIC], another processor, or any suitable combination thereof) may comprise, for example, a processor 612 and a processor 614 that may execute the instructions 616. The term “processor” is intended to comprise multi-core processors that may comprise two or more independent processors (sometimes referred to as “cores”) that may execute instructions 616 contemporaneously. Although FIG. 6 shows multiple processors 610, the machine 600 may comprise a single processor 612 with a single core, a single processor 612 with multiple cores (e.g., a multi-core processor 612), multiple processors 612, 614 with a single core, multiple processors 612, 614 with multiple cores, or any combination thereof.

The memory 630 may comprise a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may comprise a wide variety of components to receive input, provide output, produce output, transmit information, exchange information, capture measurements, and so on. The specific I/O components 650 that are comprised in a particular machine will depend on the type of machine. For example, portable machines such as mobile phones will likely comprise a touch input device or other such input mechanisms, while a headless server machine will likely not comprise such a touch input device. It will be appreciated that the I/O components 650 may comprise many other components that are not shown in FIG. 6. The I/O components 650 are grouped according to functionality merely for simplifying the following discussion, and the grouping is in no way limiting. In various example embodiments, the I/O components 650 may comprise output components 652 and input components 654. The output components 652 may comprise visual components (e.g., a display such as a plasma display panel [PDP], a light-emitting diode [LED] display, a liquid crystal display [LCD], a projector, or a cathode ray tube [CRT]), acoustic components (e.g., speakers), haptic components (e.g., a vibratory motor, resistance mechanisms), other signal generators, and so forth. The input components 654 may comprise alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may comprise biometric components 656, motion components 658, environmental components 660, or position components 662, among a wide array of other components. For example, the biometric components 656 may comprise components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may comprise acceleration sensor components (e.g., accelerometer), gravitation sensor components, rotation sensor components (e.g., gyroscope), and so forth. The environmental components 660 may comprise, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may comprise location sensor components (e.g., a Global Positioning System [GPS] receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may comprise communication components 664 operable to couple the machine 600 to a network 680 or devices 670 via a coupling 682 and a coupling 672, respectively. For example, the communication components 664 may comprise a network interface component or another suitable device to interface with the network 680. In further examples, the communication components 664 may comprise wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., coupled via a USB).

Moreover, the communication components 664 may detect identifiers or comprise components operable to detect identifiers. For example, the communication components 664 may comprise radio-frequency identification (RFID) tag reader components, NFC smart tag detection components, optical reader components (e.g., an optical sensor to detect one-dimensional bar codes such as Universal Product Code [UPC] bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

The various memories (e.g., 630, 632, 634, and/or memory of the processor[s] 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to comprise, but not be limited to, solid-state memories, and optical and magnetic media, comprising memory internal or external to processors. Specific examples of machine-storage media, computer-storage media, and/or device-storage media comprise non-volatile memory, comprising by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may comprise a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) comprising 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component comprised in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to comprise any intangible medium that is capable of storing, encoding, or carrying the instructions 616 for execution by the machine 600, and comprise digital or analog communication signals or other intangible media to facilitate communication of such software. Hence, the terms “transmission medium” and “signal medium” shall be taken to comprise any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to comprise both machine-storage media and transmission media. Thus, the terms comprise both storage devices/media and carrier waves/modulated data signals.

What is claimed is:

1. A system comprising:
at least one hardware processor;
a non-transitory computer-readable medium storing instructions that, when executed by the at least one hardware processor, cause the at least one hardware processor to perform operations comprising:
receiving a first large language model (LLM) prompt;
determining a number of input tokens in the first LLM prompt;
placing the first LLM prompt in a first bucket of a plurality of buckets in a bucket cache, based on the number of input tokens;
upon detecting that the first bucket is full, batching all LLM prompts in the first bucket into a single batch;
sending the first batch to an LLM for processing;
receiving, from the LLM, a batch of LLM results;
identifying an LLM result, in the batch of LLM results, corresponding to the first LLM prompt; and
returning the LLM result corresponding to the first LLM prompt as a response to the first LLM prompt.

2. The system of claim 1, wherein the operations further comprise:
estimating a number of output tokens that will be generated for the first LLM prompt; and
wherein the placing the first LLM prompt in the first bucket is further based on the estimated number of output tokens.

3. The system of claim 2, wherein the estimating is performed based on a type of the LLM.

4. The system of claim 2, wherein the estimating is performed based upon a maximum number of output token specified by the first LLM prompt.

5. The system of claim 2, wherein the estimating is performed based upon a default maximum number of output tokens.

6. The system of claim 2, wherein the estimating is based on historical information from performance testing of the LLM.

7. The system of claim 2, wherein the estimating is performed by a machine learning model trained to estimate a number of output tokens from one or more features of the first LLM prompt.

8. The system of claim 1, wherein the first LLM prompt is received from a virtual service configured to send the first LLM prompt to a model inference aggregator proxy instead of directly to the LLM.

9. The system of claim 1, wherein the identifying comprises checking an identification, in an aggregator proxy cache database, for the first LLM prompt.

10. A method comprising:
receiving a first large language model (LLM) prompt;
determining a number of input tokens in the first LLM prompt;
placing the first LLM prompt in a first bucket of a plurality of buckets in a bucket cache, based on the number of input tokens;
upon detecting that the first bucket is full, batching all LLM prompts in the first bucket into a single batch;
sending the first batch to an LLM for processing;
receiving, from the LLM, a batch of LLM results;
identifying an LLM result, in the batch of LLM results, corresponding to the first LLM prompt; and
returning the LLM result corresponding to the first LLM prompt as a response to the first LLM prompt.

11. The method of claim 10, further comprising:
estimating a number of output tokens that will be generated for the first LLM prompt; and
wherein the placing the first LLM prompt in the first bucket is further based on the estimated number of output tokens.

12. The method of claim 11, wherein the estimating is performed based on a type of the LLM.

13. The method of claim 11, wherein the estimating is performed based upon a maximum number of output token specified by the first LLM prompt.

14. The method of claim 11, wherein the estimating is performed based upon a default maximum number of output tokens.

15. The method of claim 11, wherein the estimating is based on historical information from performance testing of the LLM.

16. The method of claim 11, wherein the estimating is performed by a machine learning model trained to estimate a number of output tokens from one or more features of the first LLM prompt.

17. The method of claim 10, wherein the first LLM prompt is received from a virtual service configured to send the first LLM prompt to a model inference aggregator proxy instead of directly to the LLM.

18. The method of claim 10, wherein the identifying comprises checking an identification, in an aggregator proxy cache database, for the first LLM prompt.

19. A non-transitory machine-readable medium storing instructions which, when executed by one or more processors, cause the one or more processors to perform operations comprising:
receiving a first large language model (LLM) prompt;
determining a number of input tokens in the first LLM prompt;
placing the first LLM prompt in a first bucket of a plurality of buckets in a bucket cache, based on the number of input tokens;
upon detecting that the first bucket is full, batching all LLM prompts in the first bucket into a single batch;
sending the first batch to an LLM for processing;
receiving, from the LLM, a batch of LLM results;
identifying an LLM result, in the batch of LLM results, corresponding to the first LLM prompt; and
returning the LLM result corresponding to the first LLM prompt as a response to the first LLM prompt.

20. The non-transitory machine-readable medium of claim 19, wherein the operations further comprise:
estimating a number of output tokens that will be generated for the first LLM prompt; and
wherein the placing the first LLM prompt in the first bucket is further based on the estimated number of output tokens.
